(19) United States
(12) Patent Application Publication
(10) Pub. No.: US 2026/0145299 A1
(43) Pub. Date: May 28, 2026

(54) GRADUATED AND ADAPTIVE POLISHING TOOLS, AND METHOD FOR THE PRODUCTION THEREOF

(71) Applicant: SATISLOH GMBH, Wetzlar (DE)

(72) Inventors: Jens BLIEDTNER, Jena (DE); Oliver FÄHNLE, Jena (DE); Sebastian HENKEL, Jena (DE); Christian SCHULZE, Jena (DE)

(21) Appl. No.: 19/121,531

(22) PCT Filed: Oct. 5, 2023
(86) PCT No.: PCT/EP2023/077633

§ 371 Date: Apr. 16, 2025

(30) Foreign Application Priority Data
Oct. 17, 2022 (DE) 10 2022 003 886.2
Oct. 4, 2023 (DE) 10 2023 126 998.4

(51) Int. Cl. B24D 3/00; B24B 13/01; B24B 57/02; B24D 18/00; B33Y 80/00

(52) U.S. Cl. CPC B24D 3/00; B24B 13/01; B24B 57/02; B24D 18/0063; B33Y 80/00

(57) ABSTRACT

A polishing tool for processing technical surfaces includes a polishing main body and a polishing support, wherein: the polishing support has at least one polishing grain; at least one material property of the polishing support changes perpendicularly or horizontally to an axis of rotation of the polishing tool in order to be able to control a polishing removal function in a targeted manner on a surface to be processed of a workpiece; the polishing tool includes integrated cooling channels via which a polishing suspension is supplied; and the effect of the at least one polishing grain on the workpiece surface can be influenced by the change in the material property.

### TECHNICAL FIELD OF THE INVENTION

The invention relates to a polishing tool with adapted properties for the deterministic polishing of functional surfaces and to a method for producing a polishing tool.

Available polishing methods are often subdivided according to the geometry of the surface shape to be created. While what is known as a shell tool, with tool engagement over a large area, is usually used in the case of planar and spherically curved surfaces, sub-aperture tools have to be used for aspherical surfaces and free-form geometries. For the methods for which tool engagement over a large area is selected, the objective is what is known as constant removal, i.e. a constant amount of material is removed at each point on the surface over the polishing period. If this is successful, very high dimensional accuracies and a reproducible polishing process can then be achieved. For polishing methods that operate using sub-aperture tools, very high demands are placed on the axial movement as well as the synchronization of the axes to one another and significantly longer polishing times are required as a result the tool engagement over a small area. In addition, an increase in mid-frequency error influences, referred to by those skilled in the art as mid-spatial frequency errors, is unavoidable.

The increasing demands on the dimensional accuracy of optical surfaces with increasingly complex geometries require a deterministic polishing process with locally predefined removal functions. If this is successful, a targeted shape correction can be achieved while simultaneously reducing the surface roughness. For this reason, it is necessary to precisely control the required axial movements of the polishing tool. In practice, to this end, tool functions are determined on a spot lens, the required spatially different removals of material are mathematically calculated and the regions to be removed are leveled in a targeted manner using a residence-time-controlled polishing process.

In the case of said large-area and small-area polishing tools, which are based on mechano-chemical removal, the design freedom of the polishing tool is limited. For this purpose, polishing base bodies are conventionally covered with polyurethane film or pitch. In I order to increase these design freedoms, various inventions and solutions are disclosed in the prior art, with the aim of being able to influence polishing parameters in a targeted manner.

### PRIOR ART

Laid-open document JPH1199452A presents a polishing tool in the case of which the edge region of the tool has a different hardness than the inner region of the tool. To this end, use is made of an iron base body to which individual pads, which differ in terms of their hardness and height depending on their position, are attached. The outer pads, which are first of all in contact with the glass surface, have a lower hardness (Brinell≤20) in order to avoid deep cracking as a result of pressing the polishing tool.

Document JP2006231464A contains a polishing tool for machining large wafers. The polishing tool consists of annular segments that have different hardnesses in order to uniformly configure the polishing rate across the entire workpiece region. The hardness of the segments decreases from the inside to the outside. The figures disclosed depict a larger-diameter tool and a smaller workpiece.

Publication JP2006140240A likewise describes a polishing process with the use of differently arranged polishing pads. The tool is intended to be used for chemo-mechanical polishing in semiconductor technology. The aim is to reduce negative effects such as detachment, peeling and erosion of an insulating layer (low-k film, lower dielectric constant than SiO₂, εr<3.9). For this purpose, the tool is covered with two different plastic pads, which differ in terms of their hardness. The overall surface is formed from the alternately arranged individual surfaces of the pads. Although the hardness of the polishing tool can be changed in all the pad arrangements presented, it is only possible to arrange said polishing tool discretely and in a manner that is largely inflexible and unsuitable for a deterministic polishing process.

Patent JP550542B2 describes a polishing pad that has adaptive tool functions. This is intended to be used to achieve uniform evenness and at the same time to avoid polishing scratches. A base material is applied to the rear side of a urethane film using the wet coagulation process. The base material comprises two types of film elements having different Shore A hardnesses. The two types can be placed in different structures, such as grids, rings or strips, for example. Different compressive forces are intended to be produced at a constant polishing pressure so that polishing particles can move more easily.

Document CN114473855A discloses a complete tool for grinding and polishing. The tool, which is configured as both a grinding tool and a polishing tool, consists of two or more regions that differ in terms of their hardness in order to achieve different removal rates at constant grinding/polishing pressure. The use as a tool is suitable for planar surfaces for the chemo-mechanical polishing of semiconductor components. Document CN210139311U likewise presents a utility model for a polishing brush, which is intended to be used in glass polishing. The aim is to remove a uniform amount of material over the entire surface by means of variable removal rates of the individual regions. The tool is subdivided into an inner and outer circular ring region, in each of which a plurality of polishing zones with a base layer and a polishing layer are arranged. The hardness of the polishing layer in the inner region is chosen to be lower than in the outer region.

By contrast, the use of adaptive polishing tools is also described for the application region of aspherical polishing and is the subject of current research. For example, the dissertation (Scheibe 2016—Scheibe, H.: Aktiv-adaptive Polierwerkzeuge zur Herstellung rotationssymmetrischer Asphären [Active-adaptive polishing tools for producing rotationally symmetrical aspheres], Dissertation, TU Ilmenau. 2016) presents a method for polishing aspheres using a full-surface active-adaptive polishing tool. The structure of the tool consists of a tool combination of an adaptive part and an active part. The two parts are in a serial arrangement. The full-aperture contact zone between the tool and the workpiece is brought about by active deformation of the basic shape of the tool. A special needle array is proposed for the targeted sequential deformation of the tool.

All the solutions disclosed in the prior art describe different solutions for changeable hardness values of polishing tools and adaptive functionalities of the design thereof, but these are very limited in terms of the ability to be graduated and flexibility of the polishing tool functions and for deterministic polishing.

### DESCRIPTION OF THE INVENTION

The object of the invention is therefore to provide a polishing tool for deterministic polishing, the functionality of which flexibly enables a polishing removal that can be adjusted in a targeted manner at each point on the tool and additionally enables this functionality throughout the machining space, in order to thus also be able to machine aspheres and components with complex shapes, in particular free-form surfaces, in a targeted manner. The object of the invention is furthermore to provide a method for producing a tool for the graduated and adaptive polishing.

The object is achieved by the subject matter of the main claim. Advantageous embodiments are specified in the dependent claims. The polishing tool is formed by a polishing base body and a graduated polishing medium carrier. The polishing base body can be produced from the materials steel, aluminum, cemented carbide or composite materials and plastics depending on the requirement of the polishing task. The polishing medium carrier is made from a plastic, for example polyurethane, polyamide or from light-curing materials, such as acrylates and epoxy resins, for example. Preferably, the polishing medium carrier is adapted so as to be graduated rotationally symmetrically or in a targeted manner in the X and Y extents in terms of its polishing function. The polishing function results from the removal of material from the workpiece over a selected polishing period. The aim of the invention is to provide different zones of the polishing medium carrier that remove a different amount of material from the one or more differently curved workpiece surfaces. In a simple embodiment of the invention, a polishing medium carrier with two zones is provided for a rotationally symmetrical polishing tool. While the first zone has a high hardness, for example the Shore hardness D 83, in the center and surrounding region and the second zone has a lower hardness, for example a Shore hardness D of 75 in the outer region and the edge region of the polishing medium carrier, a defined different removal of material can take place on the workpiece surface. This difference in the removal function and in the resulting removal of material can advantageously be used for machining workpieces on multi-carrier bodies. If, for example, one workpiece is located in the center of a multi-carrier body and further, for example three, workpieces are distributed on a radius at a distance from the center, then different removal conditions arise during polishing on account of the different peripheral speeds of the workpieces. Experience has shown that more material is removed from the workpieces situated in the edge region than from the workpiece arranged in the center of the carrier body on account of the higher rotational speed and thus the resulting cutting speed. Preferably, the polishing medium carrier is thus configured in a targeted manner in terms of its hardness, for the two zones, according to the different removal functions. Advantageously, the zones with different required polishing properties can have not just two zones, but also a plurality of different zones, so that the required removal profile can be better approximated when polishing surfaces.

If the graduation, i.e. the number of different polishing medium carrier zones of the polishing functions, is selected to be very high, then the removal function approaches a continuous transition, from a maximum value to a minimum value of hardness, over the selected diameter of the polishing tool. Such continuous transitions are also advantageously provided in an X-Y planar extent of the polishing medium carrier, wherein a different gradient can be selected in the X extent than in the Y direction. For example, a continuous transition of the Shore D hardness of 52-77 can be selected in the X extent of the polishing medium carrier and a continuous transition of the Shore D hardness of 75-80 can be selected in the Y extent. This differing design of the polishing functions in the X and Y directions of the polishing tool enables the removal functions for off-axis workpieces, strongly curved surfaces, cylindrical lenses and cylindrical mirrors as well as free-form optical components to be adapted in a targeted manner in order to be able to carry out constant removal and a deterministic polishing process. The use of a continuously changing hardness gradient of the polishing medium carrier can be advantageously used for the changing cutting speed conditions. If the axis of rotation of the workpiece and polishing tool coincide, the cutting speed or rotational speed of the polishing tool changes from the center to the edge of the workpiece. This change can be converted into a polishing function using mathematical calculation. The polishing function represents the integral gradient from the center of the workpiece, where the (theoretical) cutting speed is equal to zero, to the edge of the workpiece, where the cutting speed is at a maximum. With knowledge of the coefficients of friction of the polishing medium carrier material used, this polishing function can be converted into a graduation distribution function of the polishing medium carrier. If the Preston coefficient is estimated sufficiently accurately and the continuous hardness gradient of the polishing medium carrier is adjusted, constant removal can thus be achieved over the entire surface to be polished. For a polishing surface of 100 cm² and the workpiece made of boron glass BK7, the Preston coefficient Cₚ=10⁻⁷ cm²N⁻¹. A normal force of F_{N}=10 N and a polishing medium carrier made of polyurethane are assumed. The experimentally determined coefficient of friction is μ=622. Particularly advantageously, these continuously changing polishing functions can also be used for large-area workpieces, for example telescopic mirrors, wafers for the semiconductor industry and cylindrical optical units.

It is advantageous to additionally vary the hardness gradient in the vertical direction. An adapted hardness gradient in the horizontal and vertical direction of the polishing medium carrier enables the resulting polishing function to be influenced in a targeted manner. The graduation of the hardness gradient in the vertical direction makes it possible to adjust a damping function of the polishing medium carrier on the polishing grain in terms of its effect on the workpiece surface, which generally follows a spring-damping model. If, for example, the restoring force of the polishing grain in the interaction zone is low and the polishing medium carrier has a high degree of damping, a small amount of material is removed at this point on the workpiece surface. In the reverse case, the damping of the polishing grain by the polishing medium carrier is very low and more material can be removed at this point. Furthermore, the polishing function over time can be changed as a result of the variation in the hardness gradient in the Z direction. This polishing function that varies over time results from wear and removal of the polishing medium carrier in the Z direction. Depending on the wear and polishing period, different hardness profiles can thus be provided by varying the hardness gradient in the Z direction. In conventional polishing processes, a polishing tool is usually constructed such that a very stiff tool base body, in steel or cast form, embodies the negative shape to be polished and a polishing medium carrier, usually made of polyurethane films or pitch, fulfills the damping function. Thus, a defined transition from hard to soft is predetermined and cannot be influenced. Preferably, however, a variation in the transition from the polishing base body and the polishing medium carrier is provided. For this purpose, the base body and the polishing medium carrier can advantageously be joined to a tool or else be produced monolithically, wherein the gradient extends over a larger region in the Z direction. This makes it possible to configure the spring-damping model for the polishing process and to be able to zonally adapt it for the corresponding polishing functions by varying the hardness and stiffness in a targeted manner over the Z extent of the tool. This makes it possible to achieve a deterministic polishing process with high reproducibility.

One particular advantage of the graduated and adaptive polishing tool is the standardization of the polishing base body. For conventional polishing processes, polishing base bodies have to be provided for each radius to be polished. Due to the large number of radii of the spherical lenses and mirrors used in optical systems and assemblies, a large number of different polishing base bodies have to be kept available or manufactured. The adaptive function of the proposed polishing medium carrier enables this large number to be reduced to a few polishing tools. This is achieved by virtue of the required radius already being directly introduced or produced during the production of the polishing medium carrier. This enables the polishing base bodies to be configured as simple planarizing tools to which the polishing medium carriers are cemented. If the required radius is insufficiently accurate, the polishing tool is dressed using a diamond tool during the polishing process. It is also possible for the polishing tool to be dressed to a different radius, so that different radii can be manufactured using one polishing tool. This requires the polishing medium carrier to have a certain center thickness in order to be capable of such multiple dressing operations. In addition, the polishing medium carrier is provided as a full-aperture negative shape for the aspherical polishing. For this purpose, the aspherical shape is also additively incorporated into the polishing medium carrier on the basis of the mathematical asphere equation. The accuracy of the polishing tool can be increased in turn by a dressing step in the polishing machine. One particular embodiment of the invention makes provision for the polishing tools to be used for the full-aperture polishing of free-form optical components. On account of the discontinuous surface transitions in free-form optical units, polishing in the kinematic arrangement typical of rotationally symmetrical components is not possible. It is advantageous to manufacture a negative shape as a polishing medium carrier from the free-form surface to be polished. In this case, during the polishing process, the active energy of the polishing grains is not transferred by a rotational movement of the polishing tool and workpiece, but by a vibratory force acting in translation between the polishing tool and workpiece. Varying the amplitude and frequency of this periodic oscillation movement additionally enables the removal to be controlled. Depending on the size and shape of the workpiece to be machined, the amplitude can reach several micrometers and the frequency can range from a few 100 HZ to the ultrasonic frequency of 60 MHz.

The graduated and adaptive polishing tools can be particularly advantageously used for constant-removal polishing and deterministic polishing. The invention is also suitable for the targeted correction polishing of components. In this regard, the surface is measured, for example interferometrically, after the polishing operation and the defects to be corrected zonally are analyzed. In accordance with this topographical defect representation over the entire surface or over individual partial regions of the workpiece surface, a further polishing function is calculated and converted into a hardness function. On the basis of this analytical evaluation, a further polishing medium carrier is produced that can eliminate the local defects in a targeted manner. In the implementation of the graduated polishing medium carrier, this means that in the zones of the workpiece surface where material is still to be removed, this region of the further polishing medium carrier is provided with a higher hardness and in the region of the workpiece surface in which no or only a small amount of material is to be removed, the region of the polishing medium carrier is provided with a low hardness or the further polishing medium carrier is omitted. In addition, regions of the further polishing medium carrier can thus be provided without material, so that no material is removed at these points.

The graduated and adaptive polishing tools are highly suitable for use with silicate materials, in particular glasses and ceramics, plastics and composite materials, metals, in particular steel, aluminum, copper and cemented carbides as well as crystals, for example silicon, germanium, zinc selenide, calcium fluoride and sapphire. The range of the required hardness values of the polishing medium carriers is adapted in dependence on the material-specific grinding or polishing hardness of the workpieces. In addition, the type and size of the polishing medium used are also taken into account for the design of the respective polishing tool. For example, cerium oxides are used as polishing media for glasses and ceramics, while aluminum oxides are used for plastics and composite materials. For materials with particularly high hardness, diamond grain is also used for polishing. The typical grain sizes for polishing using the graduated and adaptive polishing tools are in a range of the average grain diameter of 1 μm and smaller. Nanoscale polishing slurries can also be used.

Advantageously, cooling channels are introduced into the polishing tool for feeding the polishing slurry and for transporting away the workpiece material that has been removed and the worn polishing grain. These cooling channels can be formed in the lateral orientation of the polishing medium carrier, i.e. horizontally in relation to an axis of rotation of the polishing tool and/or also in the vertical direction, i.e. parallel to an axis of rotation of the polishing tool. The two cooling channel arrangements are characterized in that they can be used very flexibly and with great design freedom. Typically, structure widths of 10 μm to 5 mm are selected for the cooling channels in the lateral orientation, depending on the component size and shape. This enables micro-optical and micro-mechanical components to also be machined using the solution according to the invention. In the case of a structure width of the lateral cooling channel of 10 μm, microlenses with a minimum diameter of 0.3 mm can be polished, for example. The lateral cooling channels can be designed with a structure depth of from 100 μm up to the maximum polishing medium carrier thickness or can also have a defined change in their structure width in the Z direction. This application is particularly advantageous if the polishing medium carrier is to be used several times and has to be dressed for variable workpiece geometries. The vertical cooling channels in the polishing base body and polishing medium carrier are used for feeding the polishing medium slurry in a targeted manner. In particular for large-area polishing tools, this enables a constantly uniformly distributed flow of polishing medium to be ensured over the entire region of the workpiece surface. In addition, the invention provides the solution of configuring the structural design of the cooling channels such that they transport the polishing medium slurry while applying a defined pressure to the polishing medium carrier and the workpiece surface over their path length and the diameter of the channel. If the size and shape of the cooling channels are varied in a targeted manner over the entire polishing tool surface, a different polishing pressure can be applied to different regions of the workpiece surface. This application is particularly suitable for variable-cutting-speed polishing and correction polishing.

The object is also achieved by a method for producing the polishing tool. Advantageously, a method for layer-by-layer application of the polishing medium carrier is used. A printing process is used that can meter liquid polymer onto a platform via two print heads. The polymer with the lower Shore hardness, component A, is stored in a print head for component A 16a, and the polymer with the higher Shore hardness, component B, is stored in a print head for component B 16b. Components A and B can be made from a polymer with different hardnesses, for example acrylate, Shore D 75-83 or also from two different polymers.

The two components can be applied sequentially or in parallel during the layer-by-layer printing. The provision of a mixing unit enables component A and component B to be mixed in any proportion, so that, with an additional print head for components A and B 16c, polymers with variable percentages of component A and component B in each layer can also be printed in a varying manner. After each layer has been applied, the layers are cured using a UV radiation source. Typical layer thicknesses range from 50 μm to 200 μm. If the component is dressed again after additive manufacturing, larger layer thicknesses can also be selected. The maximum printing range in the X and Y directions of the polishing tools is typically 600 mm×600 mm. For larger polishing tools, the printing range can be extended by scaling the X and Y axes of the printing system.

Using a support material also makes it possible to provide, during printing, regions of the polishing medium carrier at which there should be no material after the tool has been completed. This applies in particular to the cooling channels or also zones in the polishing tool that are not intended to remove any material from the component. The support material used is, for example, a water-soluble polymer and is metered into the layer to be printed via a print head for the support material 16d. This print head for the support material 16d provided for this purpose can also operate sequentially or in parallel with the other material print heads. After the polishing medium carrier or polishing tool has been completed, the support material is removed from the 3D-printed body in a cleaning step. The arrangement and selection of the cooling channel geometry can be configured such that flows of polishing medium inside the polishing tool are guided in a targeted manner in order to additionally generate a different pressure distribution over the surface to be polished. If, for example, higher polishing pressures are achieved in the inner region of the polishing tool, more material can be removed from the center of the component than from the edge regions.

The possibility of applying different materials and material properties layer by layer provides the prerequisite for completely producing polishing tools in a single printing process. While the polishing base body is printed from a harder polymer in order to achieve a high stiffness, a lower hardness is selected for the polishing medium carrier. From layer to layer, a targeted graduation of the hardness can also be provided. The monolithic combination of the polishing base body and polishing medium carrier enables continuous cooling channels to be introduced. Thus, the polishing slurry within the tool can be directly fed into the active zone between the polishing medium carrier and component surface. The layer-by-layer construction enables very different geometries to be created flexibly and individually. In addition to planar polishing tools, negative shapes for spherical, aspherical and free-form surfaces can also be additively manufactured.

For polishing tasks with high demands in terms of dimensional accuracy, additional dressing of the polishing medium carrier after the printing process can be provided. For this purpose, the polishing medium carriers are cemented onto the base body and subsequently further machined using a dressing tool, for example using a diamond-bonded tool. Dressing can be carried out on a track-controlled CNC machine or directly in the polishing machine in which the polishing tool is received. A repeated dressing process enables worn polishing medium carriers to be reprocessed after the polishing operation. If polishing medium Carriers with larger center thicknesses are provided, they can also be used for different polishing tasks. Re-dressing enables, for example, radii and other surface geometries to be varied.

The invention will be explained in even greater detail below on the basis of exemplary embodiments with reference to the appended drawings, which likewise disclose features that are essential to the invention. These exemplary embodiments are merely illustrative and should not be interpreted as limiting. By way of example, a description of an exemplary embodiment with a plurality of elements or components should not be interpreted as meaning that all these elements or components are necessary for implementation. Instead, other exemplary embodiments may also contain alternate elements and components, fewer elements or components, or additional elements or components. Elements or components of different exemplary embodiments can be combined with one another, unless stated otherwise. Modifications and alterations that are described for one of the exemplary embodiments may also be applicable to other exemplary embodiments. In order to avoid repetitions, elements that are identical or correspond to one another in different figures are designated by identical reference signs and not explained several times.

### BRIEF DESCRIPTION OF THE DRAWINGS

In the drawings:

FIG. 1a shows the arrangement of the polishing tool with two zones for polishing a plurality of spherical components on a multi-carrier body,

FIG. 1b shows a sectional depiction of the polishing tool with two zones,

FIG. 2 shows a multi-zone tool for the deterministic polishing of planar workpieces,

FIG. 3a shows a plan view of a rotationally symmetrical polishing medium carrier, which has three zones of different hardnesses,

FIG. 3b shows a plan view of a square polishing medium carrier with a changing hardness gradient in each of the X and Y directions,

FIG. 3c shows a section through a polishing medium carrier with a changing hardness gradient in the Z direction,

FIG. 4a shows a plan view of a rotationally symmetrical polishing medium carrier with horizontally arranged cooling channel structures,

FIG. 4b shows a section through the polishing tool with a polishing base body and polishing medium carrier as well as the arrangement of a vertically distributed cooling channel structure,

FIG. 5a shows the sectional view of the polishing arrangement of a rotationally symmetric asphere with a full-aperture polishing tool,

FIG. 5b shows the sectional view of the polishing arrangement of a rotationally symmetric asphere with a two-part graduated sub-aperture polishing tool for sequential pre-polishing and fine polishing,

FIG. 6 shows the sectional view of the polishing arrangement of a free-form geometry with a full-aperture polishing tool and a plurality of zonal polishing functions,

FIG. 7a shows a depiction of the arrangement for printing the graduated polishing medium carriers or polishing tools with two print heads for components A and B, and

FIG. 7b shows a depiction of the arrangement for printing the graduated polishing medium carriers or polishing tools with two print heads for the material mix of component A and component B as well as for the support material.

### DETAILED DESCRIPTION OF THE DRAWINGS

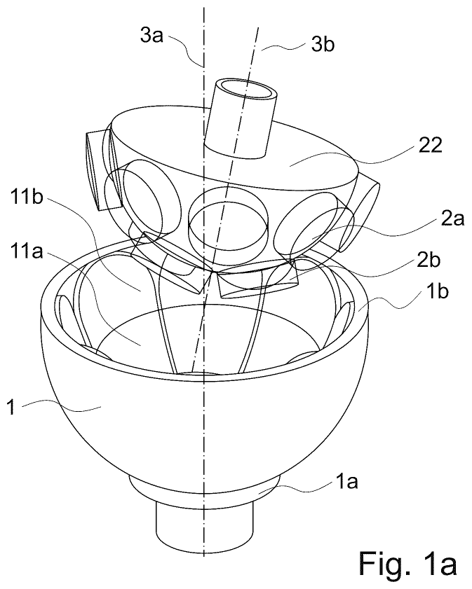

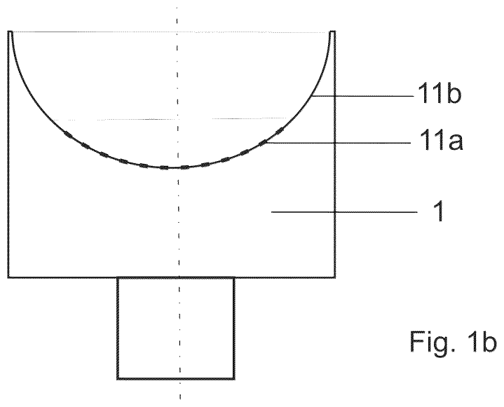

FIGS. 1a 1b depict a first exemplary embodiment. The arrangement shows a polishing tool 1 below with two different hardness zones 11.a and 11.b. This tool is used for polishing twelve convex lenses on a multi-carrier body. A first lens 2a and a second lens 2b are arranged at two different distances from an axis of rotation 3b of the workpiece carrier 22. The different peripheral speeds result in a lower cutting speed for the first lens 2a compared to the second lens 2b. As a result, more material is removed from the second lens 2b than from the first lens 2a. The selected zone division of the polishing medium carrier 1b, which corresponds to the geometrical arrangement of the lenses, makes it possible to compensate for this different removal. Accordingly, the zone 11.a is provided with a higher hardness and higher coefficient of friction than the zone 11b and is additively manufactured.

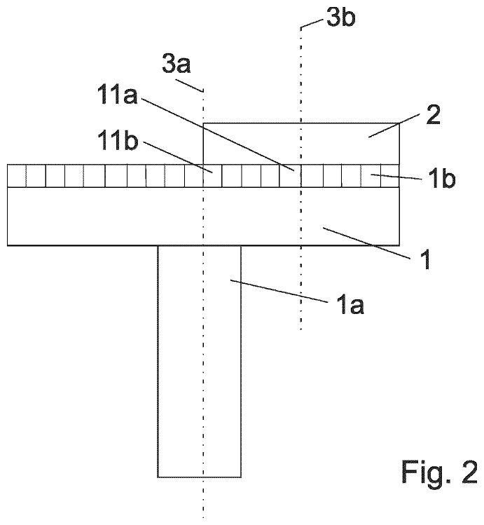

FIG. 2 depicts another exemplary embodiment for the machining of planar components. The polishing tool 1 is formed by a base body la and a multi-zone polishing medium carrier 1b. In this polishing arrangement, the axis of rotation of the workpiece 3b is offset from the axis of rotation of the polishing tool 3a by the radius of the workpiece 2. The zone 11.a is provided with a maximum hardness of 82.5 Shore D, wherein the zone 11.b has the minimum hardness value of 71.5 Shore D. Further zones are provided between the two zones, with a continuous transition. The selected continuous change in the coefficient of friction is proportional to the changing cutting speed profile. This enables constant removal over the entire surface of the component to be ensured.

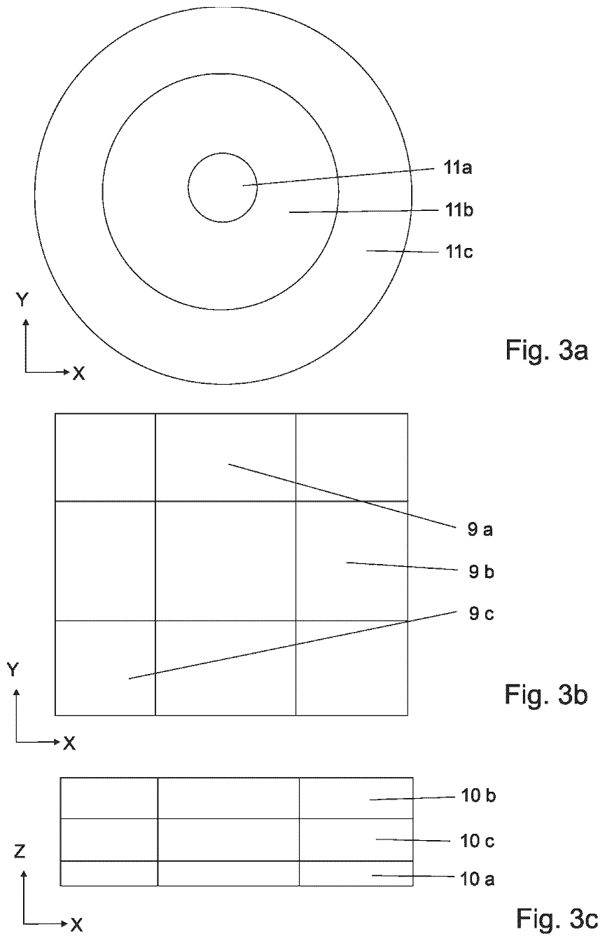

FIGS. 3a-c illustrate selected polishing medium carrier arrangements. The three depictions selected by way of example depict merely the basic hardness gradient shapes, wherein the variety of design options of the method used can significantly increase the number of zones. The selected printing method is also able to approximate the graduation of a continuous transition from a maximum selected value to a minimum value. FIG. 3a depicts a plan view of a rotationally symmetrical polishing medium carrier 1b, which has three zones of different hardness. The selected three zones 11a, 11b and 11c result in a hardness gradient, from hard to soft, from the center of the polishing medium carrier 1b outward. In the event that the surface to be polished has an edge support after the preprocessing steps, i.e. more material has to be removed from the edge, the hardness gradient can also be selected in the other direction. FIG. 3b shows a plan view of a square polishing medium carrier 1b with a changing hardness gradient in each of the X and Y directions. This arrangement illustrates the possibility of selecting the zonal gradient of the resulting polishing function. By way of example, the same hardness gradients were selected in the X and Y directions. The solution according to the invention also enables a different shape of the hardness gradient to be selected in the two axial directions. The number of adjustable zones can be selected to be as small as required, within the resolution limits of the printing method. This is typically 160 dpi. This zonal division represents a possible polishing tool arrangement for cylindrical surfaces and free-form surfaces. FIG. 3c shows a section through a polishing medium carrier 1b with a changing hardness gradient in the Z direction. Depending on the layer sequence, there can be a hardness gradient or a targeted change in hardness in each layer in the Z direction. The zonal resolution is limited by the layer thickness. Typical layer thicknesses for the additive method are in the range of from 50 to 200 μm. A combination of the hardness functions in the X, Y and Z directions simultaneously enables the defined change in the polishing pressure 21 in zonal regions of the polishing tool surface.

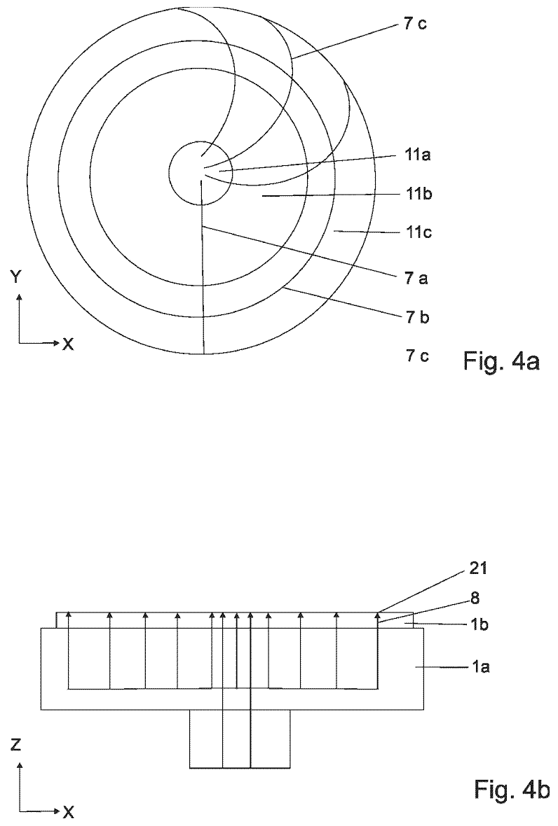

FIGS. 4a-b depict the introduction of defined cooling channels by way of example. In principle, two arrangements of cooling channel structures are possible. FIG. 4a shows the possibility of introducing cooling channels, which can be distributed over the entire surface of the polishing medium carrier 1b or else are introduced only zonally. In general, the near-surface cooling channels ensure that the polishing slurry is uniformly distributed and the removed glass residues are transported away. In this case, linear cooling channel structures 7a, concentric cooling channel structures 7b or free-form cooling channel structures 7c are introduced using the additive method. However, the distribution of the channel structures over the polishing tool surface can also be selected to be irregular, in the case of zonal polishing, if constant removal is not desired on the surface. The channel depth is between 1 and 5 mm, but can also be formed up to the entire polishing medium carrier depth in the case of the polishing medium carrier 1b being used multiple times or the polishing slurry being transferred inside the polishing tool 1, as depicted in FIG. 4b. In this arrangement, the polishing slurry feed takes place in the tool and is passed via the base body into the polishing medium carrier 1b. Selecting the size of the cooling channel, in particular the selected diameter and the number of cooling channel outlets on the tool carrier, enables the polishing pressure 21 to be adjusted to the polishing grain in a targeted manner. In this arrangement too, different polishing pressure values can be generated zonally on the polishing tool surface. In FIG. 4b, the number of integrated cooling channels in the center of the tool is selected to be greater than in the edge region. This increase in polishing pressure in the center of the polishing tool 1 can be advantageously used for polishing when the axis of rotation of the polishing tool 3a coincides with the axis of rotation of the workpiece 3b. Likewise, combining the arrangement examples from FIG. 4a with those from FIG. 4b is possible and opens up a high degree of design freedom for the deterministic polishing.

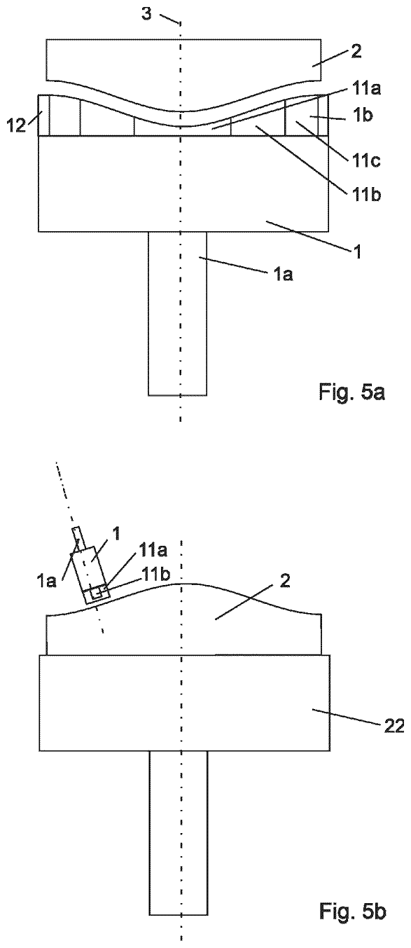

FIGS. 5a and 5b illustrate two arrangement possibilities for the deterministic polishing of aspheres. In FIG. 5a, the polishing tool 1 has been configured for a full-aperture polishing operation. The inverse asphere equation of the aspherical shape to be polished has been used as the target geometry for the additive method.

After printing, the polishing medium carrier 1b is cemented or adhesively bonded to the base body and dressed in the polishing machine using a diamond tool. Three zonal regions 11a, 11b and 11c, which are adapted to the change in the sagittal height and the distance from the center of the tool, have been selected for the gradient of the polishing function. In addition, an edge support 12 is provided, which counteracts an edge drop. This enables complex support ring arrangements on the aspherical blank, as are required for conventional aspherical polishing, to be omitted. This arrangement shown is particularly suitable for aspherical pre-polishing. Even after the aspherical fine polishing, an additional polishing step can follow using the arrangement in FIG. 5a, in order to minimize the mid-frequency error components that have arisen. The polishing time is selected to be very short for this intermediate step in order to avoid deviations from the target shape. FIG. 5b illustrates the aspherical polishing using a graduated and adaptive sub-aperture polishing tool 1. The polishing medium carrier 1b is subdivided into two zones 11a and 11b. A characteristic feature of this arrangement is that the zone 11a has a larger diameter and greater depth. This part of the polishing tool 1 is used for pre-polishing. After appropriate wear to the zone 11.a, the depths of the two zones converge. The second zone 11.b is subsequently used for fine polishing. If the wear is not high enough over the polishing period, the polishing tool 1 can be dressed to the required target depth. In the arrangement of FIG. 5b, the sub-aperture polishing tool 1 can also be guided in a meandering manner over the surface, thus enabling aspheres without rotational symmetry and free forms to be machined.

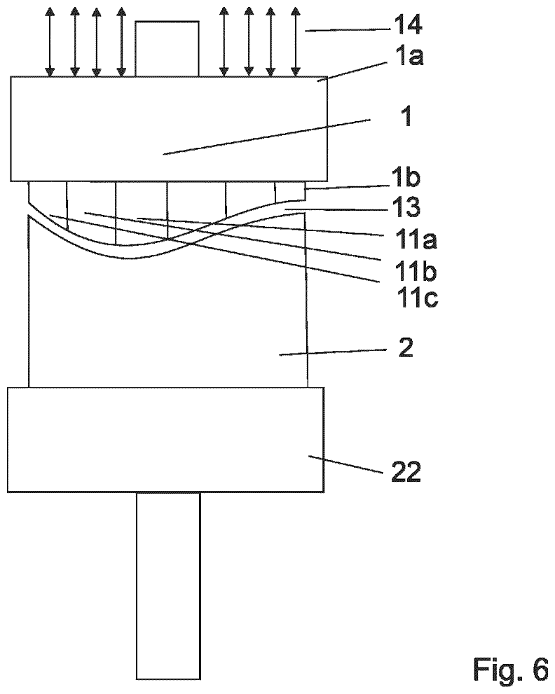

The arrangement shown in FIG. 6 is suitable for polishing

free-form surfaces. This free-form workpiece, selected simply by way of example, has a square base area of 50 mm×50 mm and a maximum component height of 40 mm. In this example too, the required negative polishing shape was additively produced as a polishing tool 1. Different zones of hardness were assigned in dependence on the changing sagittal height of the free form. A total of six differently loaded zones support the tool. For larger sagittal heights, the harder zone 11a is assigned, and for smaller sagittal heights, the zone 11b is assigned. Depending on the free-form function, this exemplary assignment may also require a significantly larger number of different zones, which can be allocated to the additive process. In this arrangement, the required active energy is transferred to the polishing grains, which are dissolved in a slurry in the active gap 13, not shown in the figure for reasons of clarity, by means of an oscillation component that acts vertically on the polishing tool 1. The polishing grain thus receives its energy in order to release the required activation potential on the workpiece surface. This required oscillation energy can be provided, for example, by an ultrasonic generator coupled with a sonotrode, or by two transducers that create an imbalance and generate a vibrating force component 14. Controlling the amplitude and frequency of the oscillating movement enables the polishing pressure 21, the coefficient of friction and the grain movement in the active gap 13 to be adapted. Selecting and graduating the polishing medium carrier 1b enables the resulting spring-damping model to thus be adjusted in a targeted manner.

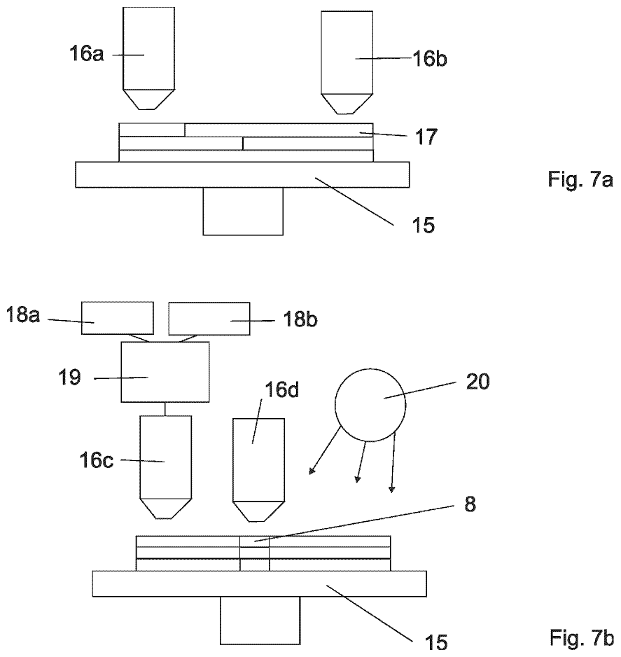

FIG. 7a and FIG. 7b each show an exemplary example of the method for producing the graduated and adaptive polishing tools 1. In FIG. 7a, use is made of two printing systems 16a and 16b, which can meter and apply minute amounts of liquid polymer. The two different components are stored in these printing systems, in this case component A with the higher hardness and component B with the lower sequentially or in parallel and apply the print volume per layer required in each case. After successful layer generation, the construction platform 15 is lowered and the subsequent layer is created. The printing system in FIG. 4b is used to provide material properties that require a continuous transition of the parameters. A mixing system 19 enables the output components A and B stored in containers 18a and 18b to be mixed with different volume percentages. This mixture provided can be metered and applied using the print head for components A+B 16c. In addition, yet another print head for the support material 16d is depicted in FIG. 7b. From this, a support material is metered and applied, which can be detached again after the construction process. Advantageously, water-soluble polymers are used as support material. This introduction of the support material is required in order to provide the necessary cooling channels 8 in the polishing tool 1. After each layer has been created, the polymer is UV cured using a UV radiation source 20.

### LIST OF REFERENCE SIGNS

1—polishing tool
1a—polishing base body
1b—polishing medium carrier
2—workpiece
2a—first lens
2b—second lens
3a—axis of rotation (polishing tool)
3b—axis of rotation (workpiece)
7a—cooling channel (linear)
7b—cooling channel (concentric)
7c—cooling channel (free-form)
8—cooling channel (vertical)
9a—higher hardness zone-translational, horizontal
9b—medium hardness zone-translational, horizontal
9c—lower hardness zone-translational, horizontal
10a—higher hardness zone-translational, vertical
10b—medium hardness zone-translational, vertical
10c—lower hardness zone-translational, vertical
11a—higher hardness zone-radial
11b—medium hardness zone-radial
11c—lower hardness zone-radial
12—edge support
13—active gap
14—translational periodic force component
15—construction platform
16a—print head for component A
16b—print head for component B
16c—print head for components A+B
16d—print head for the support material
17—printed layers
18a—component A container
18b—component B container
19—mixing unit
20—UV radiation source
21—polishing pressure

1. A polishing tool for machining technical surfaces, the polishing tool comprising:
a polishing base body; and
a polishing medium carrier having at least one polishing grain, which is configured to be dissolved in a polishing slurry in the active gap between the polishing tool and the workpiece; and
integrated cooling channels, which are used to feed the polishing slurry,
wherein at least one material property of the polishing medium carrier changes vertically or parallel in relation to an axis of rotation of the polishing tool in order to control a polishing removal function in a targeted manner on a surface to be machine of a workpiece, the at least one material property of the polishing medium carrier varying over the entire polishing medium carrier, and
the effect of the at least one polishing grain on the workpiece surface is influenced by the change in the material property of the polishing medium carrier.

2. The polishing tool as claimed in claim 1, wherein the changing material property of the polishing medium carrier is a hardness of a polishing carrier material, as a result of which a coefficient of friction of the polishing medium carrier is adjusted.

3. The polishing tool as claimed in claim 2, wherein the hardness of the polishing carrier material varies rotationally symmetrically in relation to the axis of rotation of the polishing tool.

4. The polishing tool as claimed in claim 1, wherein the at least one material property varies locally only in individual regions of the polishing medium carrier

5. (canceled)

6. The polishing tool as claimed in claim 2, wherein the polishing medium carrier has a different hardness in different regions which are disposed along a predetermined direction or two predetermined directions that are perpendicular to one another in a plane.

7. The polishing tool as claimed in claim 1, wherein at least some of the integrated cooling channels feed the polishing slurry vertically in relation to the axis of rotation and are introduced into the polishing medium carrier in one or more of linear, concentric, and free-form structures.

8. The polishing tool as claimed in claim 1, wherein some of the integrated cooling channels feed the polishing slurry horizontally in relation to the axis of rotation and are introduced into the polishing base body and the polishing medium carrier.

9. The polishing tool as claimed in claim 1, wherein the polishing tool is configured to vary a polishing pressure.

10. The polishing tool as claimed in claim 1, wherein the polishing base body and the polishing medium carrier are connected to one another.

11. The polishing tool as claimed in claim 1, wherein the polishing tool has an edge support with an adapted hardness for over-edge polishing.

12. The polishing tool as claimed in claim 1, wherein the polishing tool is configured to perform surface polishing and subaperture polishing of technical surfaces.

13. A method for producing a graduated and adaptive polishing tool for polishing using loose grain, the polishing tool including a polishing base body and a polishing medium carrier the method comprising:
providing a negative shape of the polishing medium carrier;
feeding at least two polymers to at least one print head;
creating at least one layer on the negative shape using the fed print head, as a result of which the polishing medium carrier is formed; and
adhesively bonding or cementing the formed polishing medium carrier to the polishing base body,
wherein at least two regions of the polishing medium carrier with different material properties are created, and
at least one layer of the created at least one layer has a continuous hardness gradient.

14. The method as claimed in claim 13, wherein the polymers are supplied via two separate print heads, that operate sequentially or in parallel during the creating the at least one layer.

15. The method as claimed in claim 13, wherein each polymer of the at least two polymers consists of at least two different components, the at least two different components each being mixed together by a mixer and are meterably supplied to the print heads.

16. The method as claimed in claim 13, wherein the at least one layer is cured by ultraviolet (UV) radiation.

17. (canceled)

18. The method as claimed in claim 13, wherein an additional polymer is introduced into each layer as a support material, that is removed by dissolving after the respective layer has been created.

19. The method as claimed in claim 13, further comprising dressing the shape of the polishing medium carrier in order to minimize dimensional deviation, after the creating the at least one layer.

20. The method as claimed in claim 13, further comprising dressing the shape of the polishing medium carrier after the creating the at least one layer the shape of the polishing medium carrier being adapted to a surface to be polished.
